(19) United States
(12) Patent Application Publication
(10) Pub. No.: US 2025/0118049 A1
(43) Pub. Date: Apr. 10, 2025

(54) IMAGE PROCESSING METHOD, IMAGE PROCESSING DEVICE, AND NON-TRANSITORY COMPUTER READABLE RECORDING MEDIUM

(71) Applicant: Panasonic Intellectual Property Corporation of America, Torrance, CA (US)

(72) Inventors: Risako TANIGAWA, Kanagawa (JP); Shun ISHIZAKA, Tokyo (JP); Kazuki KOZUKA, Osaka (JP)

(73) Assignee: Panasonic Intellectual Property Corporation of America, Torrance, CA (US)

(21) Appl. No.: 18/985,544

(22) Filed: Dec. 18, 2024

Related U.S. Application Data
(63) Continuation of application No. PCT/JP2023/022533, filed on Jun. 19, 2023.
(60) Provisional application No. 63/354,008, filed on Jun. 21, 2022.

(30) Foreign Application Priority Data
Apr. 27, 2023 (JP) 2023-073580

(51) Int. Cl. G06V 10/70

(52) U.S. Cl. CPC G06V 10/70

(57) ABSTRACT

An image processing apparatus acquires an image that is made by an omnidirectional imaging and has an object associated with a truth label, executes an object detection process of detecting the object in the acquired image, calculates a detection accuracy of the object in the object detection process on the basis of the truth label, and processes the image so as to increase a distortion of the object included in the image in a case where the detection accuracy is lower than a threshold.

### FIELD OF INVENTION

The present disclosure relates to a technique for processing an image.

### BACKGROUND ART

Patent Literature 1 discloses a technique of: selecting from a camera image taken by an omnidirectional camera a candidate region having a high possibility of object existence, turning a direction of the candidate region so that the object included in the selected candidate region orients in a vertical direction, and applying an object detection process to the turned candidate region.

Patent Literature 1 relates to a technique of turning a direction of a candidate region to reduce a distortion of an object included in the candidate region, but is not a technique of increasing a distortion of an object in an image. Therefore, Patent Literature 1 cannot generate a training image to accurately detect an object in an image containing a distortion.

Patent Literature 1: International Unexamined Patent Publication No. 2013/001941

### SUMMARY OF THE INVENTION

The present disclosure has been made in order to solve the problem described above, and an object thereof is to provide a technique of generating a training image to accurately detect an object in an image containing a distortion.

An image processing method according to an aspect of the present disclosure is an image processing method by a computer and includes acquiring an image made by an omnidirectional imaging, executing an object detection process of detecting an object in the acquired image, calculating a detection accuracy of the object in the object detection process; processing the image so as to increase a distortion of the object included in the image on the basis of the detection accuracy, and outputting a processed image resulting from the processing.

This configuration makes it possible to generate a training image to accurately detect an object in an image containing a distortion.

### BRIEF DESCRIPTION OF THE DRAWINGS

FIG. 1 is a block diagram showing a configuration of an exemplary image processing apparatus according to an embodiment of the present disclosure.

FIG. 2 is an illustration showing an execution of a viewpoint change process.

FIG. 3 is a diagram explaining the viewpoint change process.

FIG. 4 is an illustration showing a display picture on a user interface and carrying an image having been subjected to an object detection process by a learning model.

FIG. 5 is a flowchart showing an exemplary processing of the image processing apparatus in Embodiment 1.

FIG. 6 is a flowchart showing an exemplary processing in a training phase of the image processing apparatus 1.

FIG. 7 is an illustration showing an image having been subjected to a viewpoint change process in Embodiment 2.

FIG. 8 is a flowchart showing an exemplary processing of an image processing apparatus in Embodiment 2.

FIG. 9 is an illustration showing an exemplary object having a shape liable to involve a distortion.

FIG. 10 is a flowchart showing an exemplary processing of an image processing apparatus in Embodiment 3.

FIG. 11 is a flowchart showing an exemplary processing of an image processing apparatus in Embodiment 4.

FIG. 12 is a block diagram showing a configuration of an exemplary image processing apparatus in Embodiment 5.

FIG. 13 is a flowchart showing an exemplary processing of an image processing apparatus 1A in Embodiment 5.

### DETAILED DESCRIPTION

### Circumstances Which Led to an Aspect of the Present Disclosure

Problems in construction sites include communication problems that a specific instruction is hardly understood by an operator, or much time is consumed to explain the instruction, and confirmation problems of construction sites that much manpower is required to visit an entire construction site, and much time is required to move to a construction site.

In order to solve these problems, it may be conceived to install numerous cameras in a construction site to thereby enable a site foreman staying at a remote place to provide an operator with an instruction with reference to images obtained from the numerous cameras. However, this entails such tasks in the construction sites as detachment of attached sensors and attachment of detached sensors at other places in a progress of the construction. Since the tasks require time and effort, it is not practical to use sensors in the construction site. This is why the present inventors have studied a technique which makes it possible to remotely confirm a detailed situation in a construction site without using a sensor.

Consequently, it was found that a detailed situation in a construction site can be confirmed remotely by a user interface that displays, when a certain position in a blueprint of the construction site shown on a display is operatively selected, an omnidirectional image having been taken in advance at the certain position of the construction site, and allows a user to set an annotation region for addition of an annotation in the omnidirectional image.

For setting of an annotation region, it may be conceived to cause a display to show an omnidirectional image having been subjected to an object detection in advance by using a learning model, and to show, when a user executes an operation of selecting a certain object on the display, a bounding box associated with the certain object as the annotation region. This configuration enables the user to set an annotation region without executing operations of causing a default frame to be shown on an omnidirectional image, positioning the frame at a target object, and altering the form of the frame so as to fit the object. Thus, time and effort of the user can be reduced.

For creation of a learning model which can ensure accurate detection of an object in an image containing a distortion, it is preferable to use the image as a training image.

However, in the prior art typically represented by Patent Literature 1, an image is processed in such a way that the distortion of an object decreases to thereby improve the detection accuracy of the object. Therefore, the technical idea of processing an image so that the distortion of an object increases will not arise from the prior art.

In view thereof, the present inventors have obtained knowledge that a learning model capable of accurately detecting an object in an image representing the object with an increased distortion can be created by generating the image as a training image and causing the learning model to learn the image, and thus worked out each of the following aspects of the present disclosure.

(1) An image processing method according to an aspect of the present disclosure is an image processing method by a computer, and includes acquiring an image made by an omnidirectional imaging; executing an object detection process of detecting an object in the acquired image; calculating a detection accuracy of the object in the object detection process; processing the image so as to increase a distortion of the object included in the image on the basis of the detection accuracy; and outputting a processed image resulting from the processing.

In this configuration, a detection accuracy for the image having been subjected to the object detection process is calculated, and the image is processed so as to increase the distortion of the object on the basis of the calculated detection accuracy. This makes it possible to generate a training image to create a learning model which ensures accurate detection of the object in the image representing the object having the great distortion.

(2) In the image processing method in the above-mentioned (1), it may be appreciated that the image is an omnidirectional image having an object associated with a truth label, the detection accuracy is calculated on the basis of the truth label, and the processing is executed in a case where the detection accuracy is lower than a threshold.

In this configuration, an image in which the object detection is difficult in the object detection process is processed. This makes it possible to provide an image more suitable for training the learning model to ensure an accurate detection of an object in the image representing the object having the great distortion. Further, the detection accuracy is calculated on the basis of the truth label, which facilitates the calculation of the detection accuracy.

(3) In the image processing method in the above-mentioned (1) or (2), it may be appreciated that the image includes a first image and a second image different from the first image, the detection accuracy is related to a detection result obtained by inputting the first image to the learning model trained in advance to execute the object detection process, and the processing of the image is executed to the second image.

This configuration makes it possible to generate a training image which enables a learning model having a low detection accuracy of an object in an omnidirectional image to improve the detection accuracy. Therefore, the training of the learning model can be efficiently carried out.

(4) The image processing method in the above-mentioned (3) may further include training the learning model using the processed image.

In this configuration, the learning model is trained using an image representing an object having an increased distortion. This makes it possible to create a learning model which ensures accurate detection of an object in an image containing distortion.

(5) In the image processing method in any one of the above (2) to (4), it may be appreciated that the detection accuracy is calculated for each object class, and the second image includes an object of which detection accuracy is determined to be equal to or lower than a threshold in the first image.

In this configuration, an image including an object hardly detectable by a learning model is generated as a training image. Therefore, the learning model can be trained so as to improve the detection accuracy of the object.

(6) In the image processing method in any one of the above (1) to (5), the processing of the image may include changing a default viewpoint of the image to a viewpoint that is randomly set.

In this configuration, an image is processed by randomly changing a viewpoint thereof. This can increase the possibility of showing an object at a position causing more distortion than at a previous position before the processing. Therefore, the configuration makes it possible to generate an image representing an object having an increased distortion.

(7) In the image processing method in any one of the above (1) to (5), it may be appreciated that the processing of the image includes specifying an interval between two bonding boxes making a longest distance therebetween among those associated with a plurality of truth labels in the image; and setting a viewpoint of the image to a midpoint of the interval.

In the configuration, an image is processed so as to show an object associated with a truth label in an end portion of the image. This makes it possible to generate an image representing an object having an increased distortion.

(8) In the image processing method in any one of the above (1) to (7), it may be appreciated that the processing of the image includes: determining whether the image includes an object having at least one of an aspect ratio and a size that exceeds a reference value; and making more processed images in a case where a specific object exceeding the reference value is determined to be included than in a case where the specific object is determined not to be included.

In an omnidirectional image, a vertically long object, a horizontally long object, and an object having a large size have a high possibility of being shown with a distortion. In this configuration, in the case where such a specific object is determined to be included, more processed images are generated than in the case where it is not determined. Therefore, a training image capable of improving the detection accuracy of the specific object can be efficiently generated.

(9) In the image processing method in the above (1) or (8), it may be appreciated that the object detection process includes a rule-based object detection process, and the processing of the image is executed to the image having been subjected to the object detection process.

In this configuration, an image in which a detection accuracy of object is determined to be low in the rule-based object detection process is processed. This makes it possible to generate a training image including an object that is hardly detectable.

(10) In the image processing method in any one of the above (1) to (9), it may be appreciated that the processing of the image includes executing a viewpoint change process to increase the distortion of the object, and the viewpoint change process includes projecting the image onto a unit sphere; setting a new viewpoint depending on the projected image; and developing the projected image to a plane having the new viewpoint at a center thereof.

In this configuration, an image is projected onto a unit sphere, and a new viewpoint is set to the projected image. Accordingly, a new viewpoint can be set more easily.

(11) An image processing apparatus according to another aspect of the present disclosure is an image processing apparatus including a processor, wherein the processor executes a process including acquiring an image made by an omnidirectional imaging, executing an object detection process of detecting an object in the acquired image, calculating a detection accuracy of the object in the object detection process, processing the image so as to increase a distortion of the object included in the image on the basis of the detection accuracy, and outputting a processed image resulting from the processing.

This configuration makes it possible to provide an image processing apparatus capable of generating a training image for an accurate detection of an object in an image containing a great distortion.

(12) An image processing program according to still another aspect of the present disclosure causes a computer to execute the image processing method in any one of the above (1) to (10).

This configuration makes it possible to provide an image processing program capable of generating a training image for an accurate detection of an object in an image containing a great distortion.

The present disclosure may be implemented as an information processing system which operates in accordance with the information processing program. It is needless to say that the computer program may be distributed via a computer-readable non-transitory recording medium such as a CD-ROM or a communication network such as Internet.

In addition, each of embodiments described below shows a specific example of the present disclosure. Numerical values, shapes, constituent elements, steps, order of steps, and the like shown in the following embodiments are merely examples, and are not intended to delimit the present disclosure. Also, among the constituent elements in the following embodiments, constituent elements not recited in the independent claims representing the broadest concepts are described as optional constituent elements. In all the embodiments, the respective contents may also be combined.

### Embodiment 1

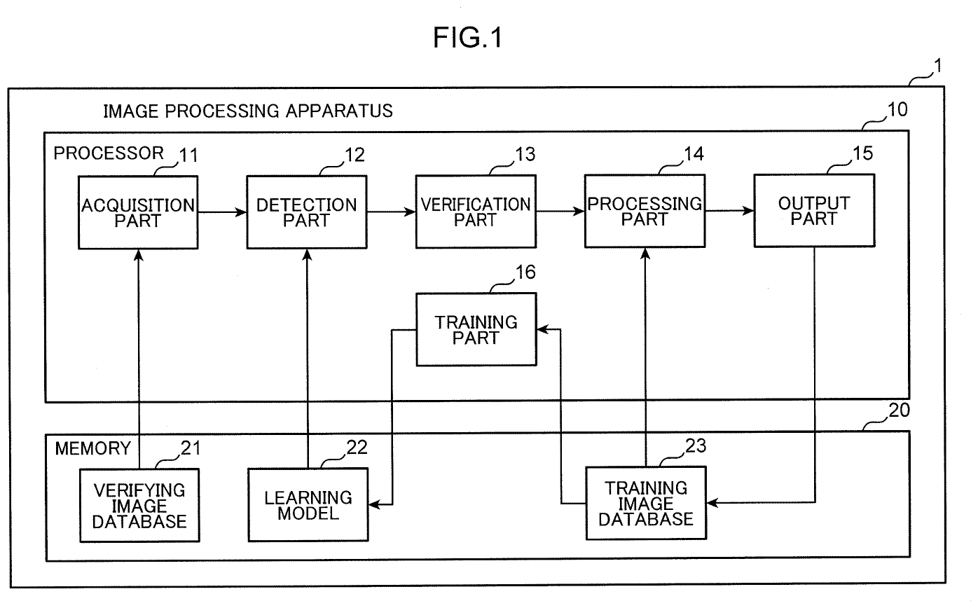

FIG. 1 is a block diagram showing a configuration of an exemplary image processing apparatus 1 according to an embodiment of the present disclosure. The image processing apparatus 1 includes a computer having a processor 10 and a memory 20. The processor 10 includes, for example, a Central Processing Unit (CPU). The processor 10 includes an acquisition part 11, a detection part 12, a verification part 13, a processing part 14, an output part 15, and a training part 16. The parts from the acquisition part 11 to the training part 16 are implemented by causing the processor 10 to execute an image processing program. The memory 20 is composed of a non-volatile rewritable storage device such as a solid-state drive (SSD). The memory 20 includes a verifying image database 21, a learning model 22, and a training image database 23. Although all the blocks are collected into a single computer in the example shown in FIG. 1, the blocks may be dispersed in a plurality of computers. In this case, the computers are mutually communicably connected via Internet, a local area network, or the like. For example, the training part 16 may be provided in a device different from the image processing apparatus 1, and the memory 20 may be provided in a device different from the image processing apparatus 1.

The acquisition part 11 acquires a verifying image from the verifying image database 21. The verifying image is an image to verify an object detection accuracy of the learning model 22. An omnidirectional image is used as the verifying image. The verifying image includes an object associated with a truth label. The verifying image is an exemplary first image. The truth label includes a bounding box indicating a position of the object in the verifying image and a class label indicating a class to which the object belongs. The omnidirectional image is an image taken by an omnidirectional camera. Although an ordinary camera cannot photograph beyond a certain inclusive angle, an omnidirectional camera can photograph in directions of 360 degrees, in other words, in all the directions, that is, upwards, downwards, leftwards, rightwards, forwards, rearwards. An omnidirectional image, which is an image resulting from a development of an image taken by an omnidirectional camera by a certain development way such as an equidistant cylindrical projection, contains different distortions that depend on positions. Therefore, in a case of detecting an object in an omnidirectional image by a learning model which has been trained using only images taken by an ordinary camera, there is a higher possibility that an object detection accuracy decreases.

The detection part 12 executes an object detection process of detecting an object in a verifying image acquired by the acquisition part 11. Specifically, the verifying image is input to the learning model 22, and the detection part 12 obtains a detection result by executing the object detection process. The learning model 22 is a model which has machine-learned in advance to execute the object detection process. The learning model 22 may include any model, such as a deep neural network, a convoluted neural network, as long as it enables detection of an object in an image. The learning model 22 is created by machine-learning a dataset of training images each including an object provided with a truth label.

The verification part 13 calculates an object detection accuracy of the learning model 22 on the basis of the truth label associated with the verifying image, and determines whether the calculated detection accuracy is lower than a threshold. For example, the detection accuracy is defined by a ratio that a denominator is a total number of objects included in the verifying image used for the verification and a numerator is the number of objects successfully detected in the object detection, i.e., an accuracy.

The verification part 13 determines the object detection to be successful when an object class label of the detection result outputted from the learning model 22 coincides with a class label included in the truth label. Alternatively, the verification part 13 may determine the object detection to be successful when the object class label of the detection result outputted from the learning model 22 coincides with the class label included in the truth label and a confidence of the object is higher than a reference confidence.

In a case where the detection result outputted from the learning model 22 includes a confidence for each object classification, the verification part 13 may determine whether a confidence for each classification is higher than a reference confidence. Further, the verification part 13 may determine the object detection to be successful when the confidence for all the classifications is higher than the reference confidence. A class indicates a type of an object.

The processing part 14 processes an image on the basis of the detection accuracy so as to increase a distortion of the object included in the image. Specifically, in a case where the detection accuracy calculated by the verification part 13 is lower than the threshold, the processing part 14 processes the training image so as to increase the distortion of the object included in the verifying image. More specifically, the processing part 14 may acquire a training image from the training image database 23, and process the training image by executing a viewpoint change process of changing a default viewpoint of the acquired training image to a viewpoint that is randomly set. Like the verifying image, the training image is an omnidirectional image, and has an object associated in advance with a truth label. The training image is an exemplary second image. Therefore, the processed image which is obtained by processing the training image inherits the truth label. Thus, the processed image which is obtained by executing the viewpoint change process to the original training image comes into existence as a training image. The default viewpoint is a viewpoint set as an initial value, for example, is parallel to a horizontal plane of the omnidirectional camera and in a north direction. A viewpoint is at a center of an omnidirectional image.

The output part 15 outputs the processed image processed by the processing part 14 to store it in the training image database 23.

The training part 16 trains the learning model 22 using the processed image stored in the training image database 23. The training part 16 calculates a training error on the basis of the truth label included in the processed image and a confidence outputted from the learning model 22, and updates a parameter of the learning model 22 in such a manner as to minimize the training error. An error backpropagation method may be adopted as a method for updating the parameter. A parameter includes a weight value and a bias value.

The verifying image database 21 stores verifying images. The learning model 22 is to be subjected to the verifying. The training image database 23 stores training images.

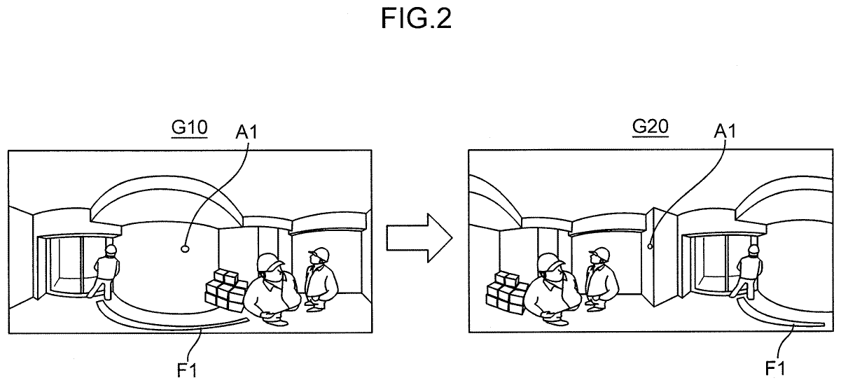

FIG. 2 is an illustration showing an execution of the viewpoint change process. An image G10 is an omnidirectional image before the viewpoint change process. An image G20 is an omnidirectional image after the viewpoint change process. In this example, the image G20 has a viewpoint A1 which is turned 180 degree horizontally from that of the image G10. In the images G10, G20, the viewpoint A1 is at a center of the images. The images G10, G20 are omnidirectional images, and contain thus different distortions that depend on positions. For example, it can be seen that left and right end portions and upper and lower end portions contain distortions greater than those in a central portion. The image G10 and the image G20 show the common object F1. The object F1 which is at a center in the horizontal direction of the image G10 shifts to an end portion in the image G20. It can be seen that the distortion increases. The application of the viewpoint change process shifts the object that is initially at the center of the image to the end portion of the image. Consequently, the distortion of the object increases.

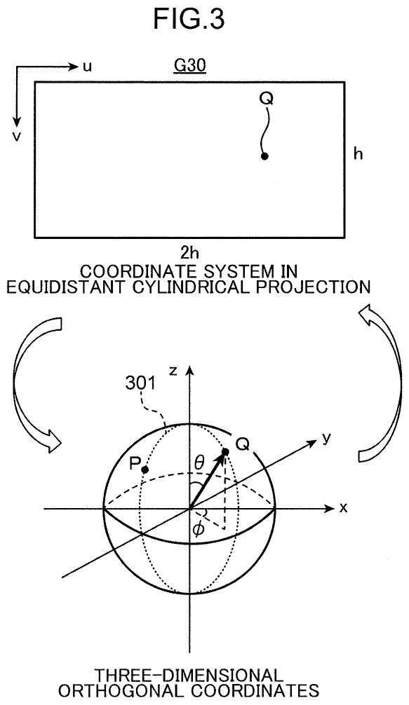

FIG. 3 is a diagram explaining the viewpoint change process. An image G30 is an omnidirectional image, and is represented by a coordinate system in the equidistant cylindrical projection. The coordinate system in the equidistant cylindrical projection (an exemplary plane) is a two-dimensional coordinate system where the horizontal direction is represented by a u-axis and a vertical direction is represented by a v-axis. The image G30 has a dimension of 2h in the horizontal direction and a dimension of h in the vertical direction.

First, the processing part 14 converts coordinates of a point Q in the image G30 to a polar coordinate system having a radius of 1. In this case, the point Q (u, v) is represented by Equations (1).

$$θ = π u / h , φ = π v / h \qquad ( 1 )$$

Where θ denotes a zenith angle, and φ denotes an azimuth angle.

Next, the processing part 14 projects the point Q from the polar coordinate system to a three-dimensional orthogonal coordinate system. In this case, the point Q (x, y, z) is represented by Equations (2).

$$x = sin θ \cdot cos φ , y = sin θ \cdot sin φ , z = cos φ \qquad ( 2 )$$

Next, the processing part 14 sets respective rotation matrices Y(φy), P(θp), and R(φr) about three axes that are yaw, pitch, and roll axes. φy denotes a rotation angle about the yaw axis, θp denotes a rotation angle about the pitch axis, and or denotes a rotation angle about the roll axis. Accordingly, the point Q (x, y, z) is projected to a point Q′ (x′, y′, z′) as represented by Equation (3).

$$\begin{matrix}[ Mathematical Expression 1 ] & \\ [ \begin{matrix}{x}^{′} \\ {y}^{′} \\ {z}^{′}\end{matrix} ] = Y ( {ψ}_{y} ) P ( {θ}_{p} ) R ( {ϕ}_{r} ) [ \begin{matrix}x \\ y \\ z\end{matrix} ] & ( 3 )\end{matrix}$$

$$R ( {ϕ}_{r} ) = [ \begin{matrix}1 & 0 & 0 \\ 0 & cos {ϕ}_{r} & - sin {ϕ}_{r} \\ 0 & sin {ϕ}_{r} & cos {ϕ}_{r}\end{matrix} ] , P ( {θ}_{p} ) = [ \begin{matrix}cos {θ}_{p} & 0 & sin {θ}_{p} \\ 0 & 1 & 0 \\ - sin {θ}_{p} & 0 & cos {θ}_{p}\end{matrix} ] , Y ( {ψ}_{y} ) = [ \begin{matrix}cos {ψ}_{y} & - sin {ψ}_{y} & 0 \\ sin {ψ}_{y} & cos {ψ}_{y} & 0 \\ 0 & 0 & 1\end{matrix} ]$$

Next, the processing part 14 converts the point Q′ from the orthogonal coordinate system to the polar coordinate system using Equations (4), where θ′ denotes a zenith angle after the conversion, and φ′ denotes an azimuth angle after the conversion.

$$\begin{matrix}[ Mathematical Expression 2 ] & \\ {θ}^{′} = {cos}^{- 1} {z}^{′} , {ϕ}^{′} = {tan}^{- 1} ( \frac{{y}^{′}}{{x}^{′}} ) & ( 4 )\end{matrix}$$

Then, the processing part 14 converts the point Q′ from the polar coordinate system to the coordinate system in the equidistant cylindrical projection. In this case, the point Q′ is represented by Equations (5).

$${u}^{′} = {θ}^{′} h / π , {v}^{′} = {φ}^{′} h / π \qquad ( 5 )$$

The processing described above is executed for all the points in the image G30 to accomplish the viewpoint change process to the image G30, where u′ represents a coordinate on the u axis after the viewpoint change, and v′ represents a coordinate on the v axis after the viewpoint change.

In Embodiment 1, the processing part 14 randomly sets the above-mentioned rotation angles φr, θp, and φy to thereby randomly change the viewpoint of the image G30. Specifically, the processing part 14 sets as the viewpoint a center of the image G30, which is obtained after being rotated at the rotation angles φr, θp, and φy, in an equidistant cylindrical coordinate system. In embodiments to be described later, the processing part 14 executes the viewpoint change process not randomly but in ways corresponding to respective embodiments.

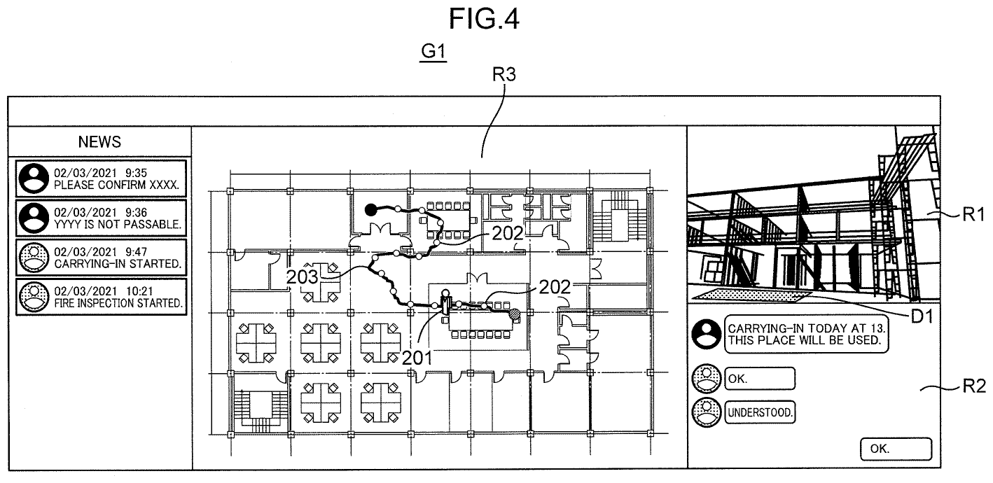

Hereinafter, an application of an image having been subjected to the object detection process by the learning model 22 will be described. FIG. 4 is an illustration showing a display picture G1 on a user interface and carrying an image having been subjected to the object detection process by the learning model 22.

The display picture G1 is a basic picture of an application for a remote user to confirm a situation in a work site. The display picture G1 includes an image display field R1, an annotation information display field R2, and a blueprint display field R3. A blueprint of the work site is displayed in the blueprint display field R3. A selection icon 201, an image taking point icon 202, and a path 203 are displayed superimposed over the blueprint. An operator has performed in advance an image taking operation using an omnidirectional camera in this work site. The image taking point icons 202 respectively indicate positions where images are taken during the image taking operation. The path 203 indicates a path showing a movement of the operator in the image taking operation.

The user operatively selects one image taking point icon 202 by dragging and dropping the selection icon 201 on the blueprint. Accordingly, an omnidirectional image of the work site having been taken at the image taking point indicated by the selected one image taking point icon 202 is shown in the image display field R1. The user sets an annotation region D1 to the image shown in the image display field R1, and inputs an annotation message concerning the annotation region D1 to the annotation information display field R2. Thus, the annotation region D1 and the annotation message are shared by users. Consequently, the remote user can confirm a newly updated situation and cautions on the work site in detail without moving to the work site.

The omnidirectional image shown in the image display field R1 has been subjected to the object detection process in advance by the learning model 22. Therefore, when the user operatively selects in the omnidirectional image an object about which the user wishes to make an annotation, a bounding box of the object is shown, and the user can set the annotation region D1 on the basis of the bounding box. This enables the user to set the annotation region D1 without executing operations of causing a frame for setting the annotation region D1 to be shown in the image display field R1, moving the frame to a position of the target object, and altering the form of the frame so as to fit a form of the object.

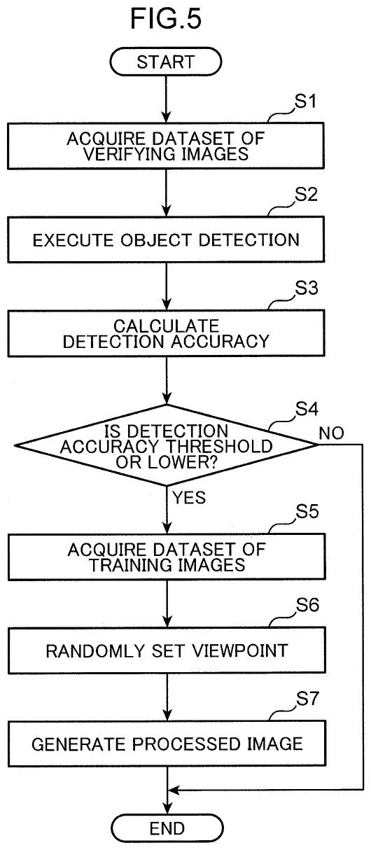

FIG. 5 is a flowchart showing an exemplary processing of the image processing apparatus 1 in Embodiment 1. First, in Step S1, the acquisition part 11 acquires a dataset of verifying images including a predetermined number of verifying images from the verifying image database 21.

Next, in Step S2, the detection part 12 sequentially inputs the verifying images constituting the dataset of verifying images to the learning model 22 to allow detection of an object included in the verifying images.

Next, in Step S3, the verification part 13 calculates the above-described accuracy by comparing the object detection result of the learning model 22 with the truth label in the dataset of verifying images acquired in Step S1, and determines the calculated accuracy to be the detection accuracy of the learning model 22.

Next, the verification part 13 determines whether the detection accuracy calculated in Step S3 is equal to or lower than a threshold (Step S4). When the detection accuracy is determined to be equal to or lower than the threshold (YES in Step S4), the processing part 14 acquires from the training image database 23 a dataset of training images including a predetermined number of training images (Step S5).

Next, the processing part 14 randomly sets a viewpoint of each training image (Step S6). Specifically, as described above, the viewpoint is randomly set by randomly setting the rotation angles φr, θp, φy.

Next, the processing part 14 executes the viewpoint change process to each training image to thereby generate a processed image having the set viewpoint changed from the default viewpoint (Step S7). The generated processed image is stored in the training image database 23. The processing part 14 may randomly set K (K is an integer of 2 or greater) viewpoints for a single training image to thereby generate K processed images. Thus, a plurality of processed images that represent an object with various distortions are generated from the single training image. Consequently, processed images suitable for training the learning model 22 can be efficiently generated.

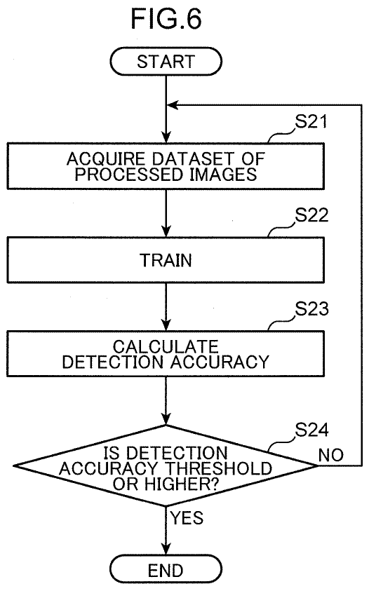

Hereinafter, a machine learning in the image processing apparatus 1 will be described. FIG. 6 is a flowchart showing an exemplary processing in a training phase of the image processing apparatus 1.

First, in Step S21, the training part 16 acquires a dataset of processed images including a predetermined number of processed images from the training image database 23.

Next, in Step S22, the training part 16 sequentially inputs the dataset of processed images to the learning model 22 to thereby train the learning model 22.

Next, in Step S23, the training part 16 compares the object detection result of the learning model 22 with a truth label included in the processed image for all the processed images acquired in Step S22 to thereby calculate an accuracy of the object detection, and determines the calculated accuracy to be the detection accuracy of the learning model 22. The way of calculating the detection accuracy by the training part 16 is the same as the way used by the verification part 13. In other words, the training part 16 calculates as the detection accuracy a ratio that the denominator is the total number of training images in the dataset acquired in Step S5 and the numerator is the number of training images leading to the successful object detection.

Next, in Step S24, the training part 16 determines whether the detection accuracy is equal to or higher than a threshold. As the threshold, a proper value such as 0.8 and 0.9 may be adopted. When the detection accuracy is equal to or higher than the threshold (YES in Step S24), the process ends. On the other hand, when the detection accuracy is lower than the threshold (NO in Step S24), the process returns to Step S21. In this case, the training part 16 may acquire again a dataset of processed images from the training image database 23 and execute the training of the learning model 22. The dataset of processed images to be used may or may not include the same processed image as the processed image used for the training in the previous loop.

Accordingly, the training of the learning model 22 by use of the processed images is executed until the detection accuracy becomes equal to or higher than the threshold. This makes it possible to create the learning model 22 which ensures an accurate detection of an object from an omnidirectional image.

In this manner, in this embodiment, a detection accuracy of the learning model 22 having detected an object from a verifying image is calculated on the basis of a truth label, and when the calculated detection accuracy is equal to or lower than a threshold, a training image is processed so as to increase the distortion of the object. This makes it possible to generate a training image to create a learning model which ensures accurate detection of the object from an omnidirectional image.

Further, in this embodiment, the image is processed on the basis of a viewpoint that is randomly set. This can increase the possibility of showing an object at a position causing more distortion than at a previous position before the processing. Therefore, an image representing an object having an increased distortion can be generated.

### Embodiment 2

In Embodiment 2, a viewpoint is set to a midpoint of an interval between two truth labels, the interval being the longest among a plurality of intervals between truth labels. In Embodiment 2, the same constituent elements as those of Embodiment 1 will be allotted with the same reference numerals, and the description thereof will be omitted. Further, in Embodiment 2, FIG. 1 which is the block diagram will be used for the description.

The processing part 14 shown in FIG. 1 converts an omnidirectional image (hereinafter referred to as original image) before a viewpoint change process and a bounding box associated with the original image onto a unit sphere using the above-described Equations (1) and (2). The conversion onto the unit sphere is executed using the above-described Equations (1) and (2). Next, the processing part 14 specifies two bounding boxes having the longest interval therebetween among a plurality of bounding boxes plotted on the unit sphere. As shown in FIG. 3, two points indicating positions of the two bounding boxes on the unit sphere are allotted with P and Q. A centroid of the bounding box can be used as the position of the bounding box. The interval means the longer of two arcs delimited by the points P and Q on a great circle 301 passing the points P and Q. Next, the processing part 14 specifies two bounding boxes having the longest interval therebetween, and sets the viewpoint to a midpoint of the interval between the two bounding boxes. Next, the processing part 14 develops the original image on the unit sphere in such a manner that the viewpoint is at a center of an equidistant cylindrical coordinate system. Accordingly, objects corresponding to the two bounding boxes having the longest interval therebetween are shown at ends where greater distortions occur in the omnidirectional image. The omnidirectional image representing the objects having increased distortions can be thus obtained.

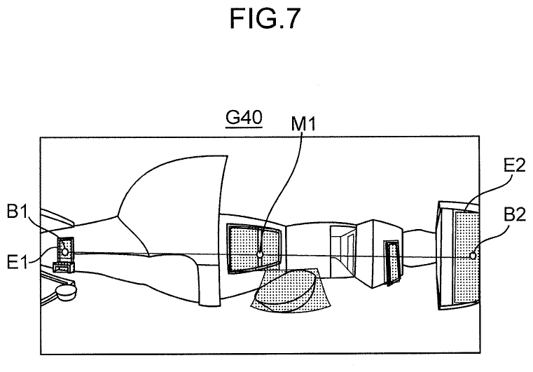

FIG. 7 is an illustration showing an image G40 having been subjected to a viewpoint change process in Embodiment 2. In the image G40, with respect to window, chair, bathtub, light, mirror, and door, their respective class labels and bounding boxes are associated with them. In this example, in an original image, an interval L between a position B1 of a bounding box E1 of a chair and a position B2 of a bounding box E2 of a door is determined to be the longest. Therefore, the original image is developed in such a manner that the viewpoint comes to be at a midpoint M1 of the interval L. Consequently, the image G40 is obtained. The chair and the door are shifted to both end portions where the distortion is greater in the image G40. Thus, the distortions of the objects are increased.

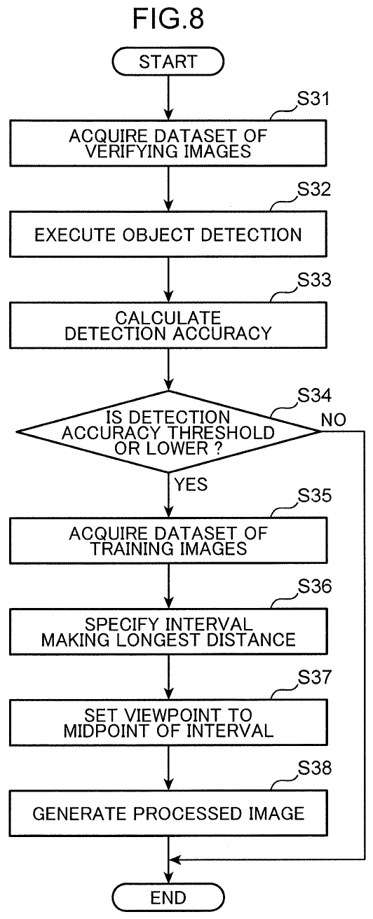

FIG. 8 is a flowchart showing an exemplary processing of an image processing apparatus 1 in Embodiment 2. The processes in Steps S31 to S35 are identical to the processes in Steps S1 to S5 in FIG. 5. In Step S36, the processing part 14 specifies an interval which is the longest among a plurality of intervals between a given pair of bounding boxes among a plurality of bounding boxes associated with training images.

Next, in Step S37, the processing part 14 sets the viewpoint to a midpoint of the interval.

Next, in Step S38, a processed image is generated by developing the training image in such a manner that the set viewpoint is at a center thereof. The processed image representing objects with greater distortions than that before the viewpoint change process can be thus obtained.

In Embodiment 2, the training image is processed so as to show objects associated with truth labels at positions causing greater distortions. This makes it possible to generate a processed image representing an object having an increased distortion.

### Embodiment 3

In Embodiment 3, in generation of processed images, much more processed images include an object having a shape liable to involve a distortion in an omnidirectional image. In Embodiment 3, the same constituent elements as those of Embodiments 1 and 2 will be allotted with the same reference numerals, and the description thereof will be omitted. Further, in Embodiment 3, FIG. 1 which is the block diagram will be used for the description.

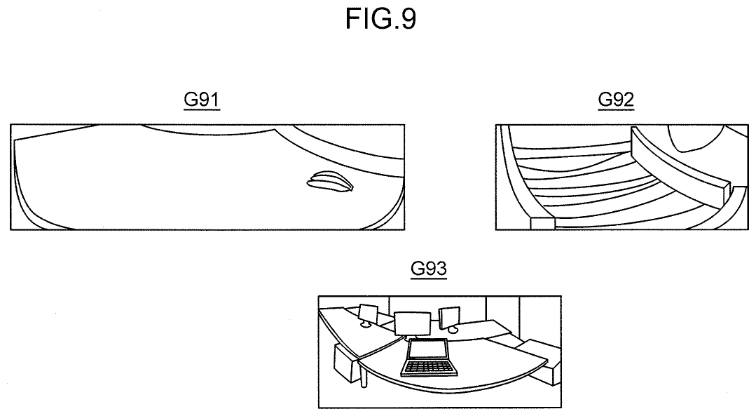

FIG. 9 is an illustration showing an exemplary object having a shape liable to involve a distortion. An object which has an aspect ratio exceeding a reference aspect ratio and a size exceeding a reference size is the object having a shape liable to involve a distortion. Objects shown in images G91, G92 are building materials having aspect ratios exceeding respective reference aspect ratios. An image G93 shows an object which is a building material having a size equal to or greater than a reference size. Examples of the object having a shape liable to involve a distortion include a horizontally long sofa, a bathtub, a ceiling light, and a door. The aspect ratio includes a ratio of a horizontal side to a vertical side and a ratio of the vertical side to the horizontal side of a bounding box associated with an object.

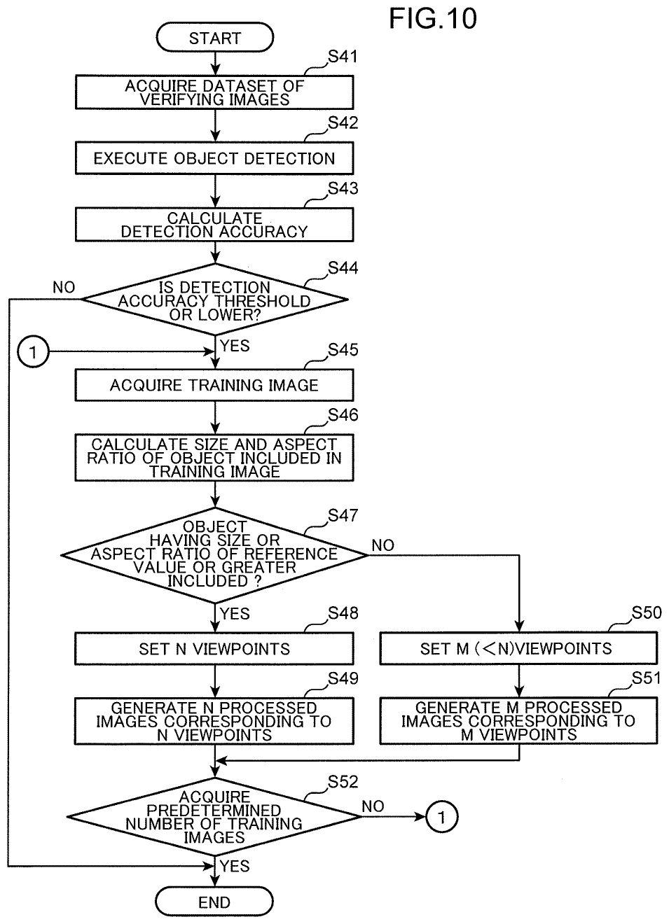

FIG. 10 is a flowchart showing an exemplary processing of an image processing apparatus 1 in Embodiment 3. Since Steps S41 to S44 are identical to S1 to S4 in FIG. 5, the description thereof will be omitted. In Step S45, the processing part 14 acquires a training image from the training image database 23.

Next, in Step S46, the processing part 14 calculates a size and an aspect ratio of an object included in the training image. For example, the processing part 14 calculates the size of the object on the basis of an area of the bounding box associated with the training image. The processing part 14 calculates an aspect ratio on the basis of lengths of a vertical side and a horizontal side of the bounding box associated with the training image.

Next, in Step S47, the processing part 14 determines whether a specific object having a size equal to or greater than a reference size or an aspect ratio equal to or greater than a reference aspect ratio is included in the training image. When the specific object is included in the training image (YES in Step S47), the processing part 14 randomly sets N (N is an integer equal to or greater than 2) viewpoints in the training image (Step S48). The processing part 14 may set the N viewpoints using the way used in Embodiment 1. “Two” is an example for N.

Next, the processing part 14 generates N processed images corresponding to the N viewpoints (Step S49). The processing part 14 may generate the N processed images by executing viewpoint change processes in such a manner as to change the default viewpoint to the set N viewpoints.

When the specific object having a size equal to or greater than the reference size or an aspect ratio equal to or greater than the reference aspect ratio is not included in the training image (NO in Step S47), the processing part 14 randomly sets M (M is an integer equal to or greater than 1 and smaller than N) viewpoints in the training image (Step S50). “One” is an example for M. The way of randomly setting a viewpoint is the same as that of Embodiment 1.

Next, in Step S51, the processing part 14 generates M processed images corresponding to the M viewpoints. The processing part 14 may generate the M processed images by executing viewpoint change processes in such a manner as to change the default viewpoint to the set M viewpoints.

Next, the processing part 14 determines whether a predetermined number of training images are acquired from the training image database 23 (Step S52). When the predetermined number of training images are acquired (YES in Step S52), the process ends. On the other hand, when the predetermined number of training images are not acquired (NO in Step S52), the process returns to step S45, and a training image to be subsequently processed is acquired from the training image database 23.

Accordingly, in Embodiment 3, when an object having a shape liable to involve a distortion, e.g., a vertically long object, a horizontally long object, and an object having a large size, is determined to be included in the training image, more processed images are generated than when it is not determined. Therefore, a training image capable of improving a detection accuracy of an object can be efficiently generated.

### Embodiment 4

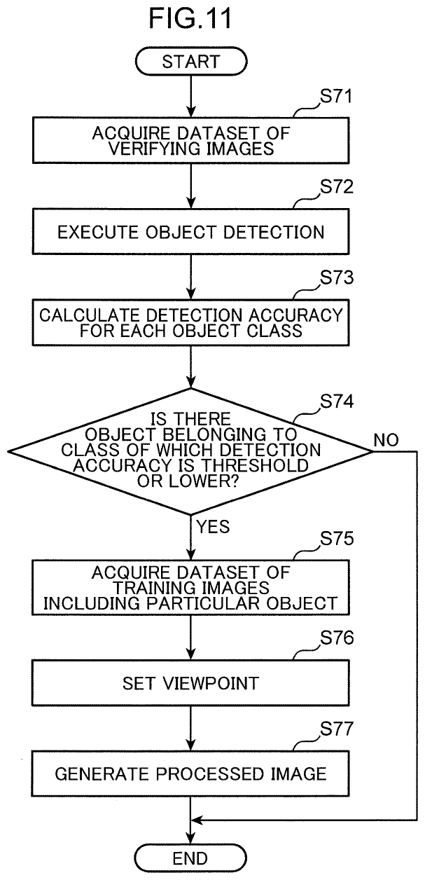

In Embodiment 4, more processed images including an object hardly detectable by the learning model 22 are generated. In Embodiment 4, the same constituent elements as those of Embodiments 1 to 3 will be allotted with the same reference numerals, and the description thereof will be omitted. Further, in Embodiment 4, FIG. 1 which is the block diagram will be used for the description. FIG. 11 is a flowchart showing an exemplary processing of an image processing apparatus 1 in Embodiment 4. Since the processes in Steps S71, S72 are identical to those in Steps S1, S2 in FIG. 5, the description thereof will be omitted. In Step S73, the verification part 13 calculates an object detection accuracy in each verifying image for each object class. For example, in a case where the class of an object to be detected includes sofa, ceiling light, door classes, respective detection accuracies of the sofa, the ceiling light, and the door are calculated.

Next, in Step S74, the verification part 13 determines whether there is an object belonging to a class of which detection accuracy is equal to or lower than a threshold. Hereinafter, the object belonging to a class of which detection accuracy is equal to or lower than a threshold is called as a particular object. When it is determined that there is the particular object (YES in Step S74), the processing part 14 acquires a dataset of training images including a predetermined number of training images including the particular object from the training image database 23 (Step S75). On the other hand, when it is determined that there is not the particular object (NO in Step S74), the process ends.

Next, in Step S76, the processing part 14 sets a viewpoint in the training image. For example, the processing part 14 may randomly set the viewpoint as described in Embodiment 1, or may set the viewpoint to a midpoint of the longest interval as described in Embodiment 2.

Next, in Step S77, the processing part 14 generates processed images by executing the viewpoint change processes to the respective training images in such a manner as to change the default viewpoint to the set viewpoints (Step S77). For example, the processing part 14 may generate a processed image by executing the viewpoint change process described in Embodiment 1 or Embodiment 2.

Accordingly, in Embodiment 4, a training image including an object hardly detectable by a learning model is generated. Therefore, the learning model can be trained so as to improve the detection accuracy of the object.

### Embodiment 5

In Embodiment 5, an object detection process is executed to an omnidirectional image using a rule-based object detection process, and the processing is executed to the omnidirectional image having been subjected to the object detection process. In Embodiment 5, the same constituent elements as those of Embodiments 1 to 4 will be allotted with the same reference numerals, and the description thereof will be omitted.

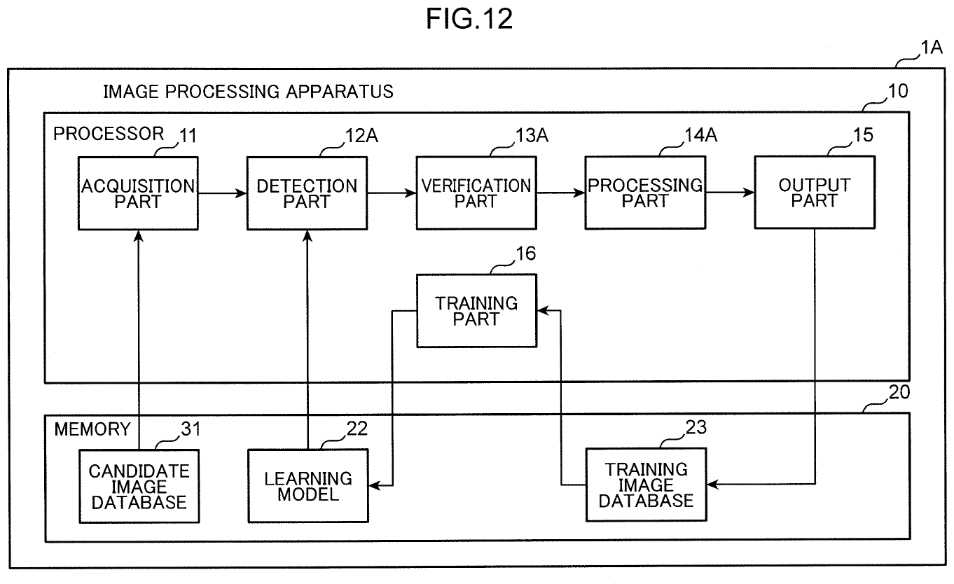

FIG. 12 is a block diagram showing a configuration of an exemplary image processing apparatus 1A in Embodiment 5. FIG. 12 differs from FIG. 1 in that a candidate image database 31 is stored in the memory 20 in place of the verifying image database 21, and that the processor 10 includes a detection part 12A, a verification part 13A, and a processing part 14A in place of the detection part 12, the verification part 13, and the processing part 14.

The candidate image database 31 stores a candidate image that is a candidate for the training of the learning model 22. Like the verifying image, the candidate image is an omnidirectional image associated with a truth label.

The detection part 12A detects an object in a candidate image by executing a rule-based object detection process to the candidate image acquired by the acquisition part 11. A process of detecting an object in an image without using a learning model obtained by machine learning is the rule-based object detection process. Examples of the rule-based object detection process include a pattern matching and a process of detecting an object on the basis of a shape of an edge that is included in an image and has been detected in an edge detection. A class to which an object to be detected belongs is determined in advance. Therefore, a template used for the pattern matching corresponds to the class to which the object to be detected belongs. The detection part 12A calculates a similarity for each class by applying a template corresponding to each class to the candidate image.

The verification part 13A determines the similarity calculated by the detection part 12A to be a detection accuracy in the object detection process, and determines whether the detection accuracy is lower than a threshold. In a case where similarities for all the classes are lower than the threshold, the verification part 13 may determine that the detection accuracy is lower than the threshold.

When the detection accuracy calculated by the verification part 13A is determined to be lower than the threshold, the processing part 14A processes the candidate image so as to increase the distortion of the object included in the candidate image.

The output part 15 stores the processed images processed by the processing part 14A in the training image database 23. This allows the learning model 22 to learn the processed images obtained by processing the candidate image.

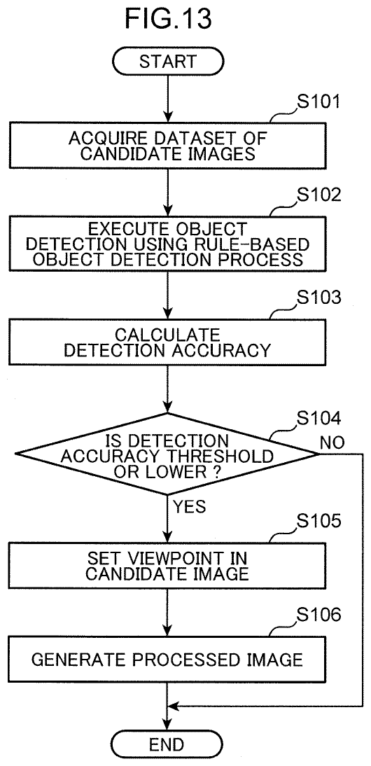

FIG. 13 is a flowchart showing an exemplary processing of an image processing apparatus 1A in Embodiment 5. First, in Step S101, the acquisition part 11 acquires a dataset of candidate images from the candidate image database 31.

Next, the detection part 12A executes detection of an object in each of the candidate images included in the acquired dataset of candidate images by executing a rule-based object detection process to the candidate images (Step S102).

Next, in Step S103, the verification part 13A determines the similarity calculated during the detection of the object by the detection part 12A to be the detection accuracy.

Next, in Step S104, the verification part 13A determines whether the detection accuracy is equal to or lower than a threshold. When the detection accuracy is equal to or lower than the threshold (YES in Step S104), the processing part 14A sets a viewpoint in the candidate image (Step S105). For example, the processing part 14A may randomly set the viewpoint as described in Embodiment 1, or may set the viewpoint to a midpoint of the longest interval as described in Embodiment 2. When the detection accuracy is higher than the threshold (NO in Step S104), the process ends.

Next, in Step S106, the processing part 14A generates a processed image by executing the viewpoint change process to the candidate image in such a manner as to change the default viewpoint to the set viewpoint (Step S106). For example, the processing part 14A may generate the processed image by executing the viewpoint change process described in Embodiment 1 or that described in Embodiment 2. The processed image is stored in the training image database 23.

Accordingly, in Embodiment 5, a candidate image which is determined to provide a low detection accuracy of an object in the rule-based object detection process is processed. The processed training image including the object can be thus generated.

The present disclosure may adopt the following modifications.
(1) An omnidirectional image to be processed, which is a training image stored in the training image database 23 in Embodiments 1 to 4, may be a verifying image.
(2) The way of acquiring a training image including a particular object from the training image database 23 described in Embodiment 4 may be included in Embodiments 1 to 3.
(3) In the above description of the embodiments, the site is exemplified by a construction site. However, the present disclosure is not limited thereto, and the site may be a production site, a logistic site, a distribution site, an agricultural land, a civil engineering site, a retail site, an office, a hospital, commercial facilities, caregiving facilities, or the like.

The present disclosure is useful in the technical field in which an object detection in an omnidirectional image is executed.

1. An image processing method, by a computer, comprising:
acquiring an image made by an omnidirectional imaging;
executing an object detection process of detecting an object in the acquired image;
calculating a detection accuracy of the object in the object detection process;
processing the image so as to increase a distortion of the object included in the image on the basis of the detection accuracy; and
outputting a processed image resulting from the processing.

2. The image processing method according to claim 1, wherein
the image is an omnidirectional image having an object associated with a truth label,
the detection accuracy is calculated on the basis of the truth label, and
the processing is executed in a case where the detection accuracy is lower than a threshold.

3. The image processing method according to claim 1, wherein
the image includes a first image and a second image different from the first image,
the detection accuracy is related to a detection result obtained by inputting the first image to a learning model trained in advance to execute the object detection process, and
the processing of the image is executed to the second image.

4. The image processing method according to claim 3, further comprising:
training the learning model using the processed image.

5. The image processing method according to claim 3, wherein
the detection accuracy is calculated for each object class, and
the second image includes an object of which detection accuracy is determined to be equal to or lower than a threshold in the first image.

6. The image processing method according to claim 1, wherein the processing of the image includes changing a default viewpoint of the image to a viewpoint that is randomly set.

7. The image processing method according to claim 1, wherein
the processing of the image includes:
specifying an interval between two bonding boxes making a longest distance therebetween among those associated with a plurality of truth labels in the image; and
setting a viewpoint of the image to a midpoint of the interval.

8. The image processing method according to claim 1, wherein
the processing of the image includes:
determining whether the image includes an object having at least one of an aspect ratio and a size that exceeds a reference value; and
making more processed images in a case where a specific object exceeding the reference value is determined to be included than in a case where the specific object is determined not to be included.

9. The image processing method according to claim 1, wherein
the object detection process includes a rule-based object detection process, and
the processing of the image is executed to the image having been subjected to the object detection process.

10. The image processing method according to claim 1, wherein
the processing of the image includes executing a viewpoint change process to increase the distortion of the object, and
the viewpoint change process includes
projecting the image onto a unit sphere;
setting a new viewpoint depending on the projected image; and
developing the projected image to a plane having the new viewpoint at a center thereof.

11. An image processing apparatus including a processor, wherein
the processor executes a process including:
acquiring an image made by an omnidirectional imaging;
executing an object detection process of detecting an object in the acquired image;
calculating a detection accuracy of the object in the object detection process;
processing the image so as to increase a distortion of the object included in the image on the basis of the detection accuracy; and
outputting a processed image resulting from the processing.

12. A non-transitory computer readable recording medium storing an image processing program for causing a computer to execute a process of:
acquiring an image made by an omnidirectional imaging;
executing an object detection process of detecting an object in the acquired image;
calculating a detection accuracy of the object in the object detection process;
processing the image so as to increase a distortion of the object included in the image on the basis of the detection accuracy; and
outputting a processed image resulting from the processing.
